(19) United States
(12) Patent Application Publication
(10) Pub. No.: US 2008/0145183 A1
(43) Pub. Date: Jun. 19, 2008

(54) SCREW WITH A RECESS IN THE HEAD OF THE SCREW

(76) Inventor: Teng-Hung Lin, Kaohsiung Hsien (TW)

Correspondence Address: TENG-HUNG LIN, 235 Chung - Ho, Box 8-24, Taipei, omitted

(21) Appl. No.: 12/017,061

(22) Filed: Jan. 21, 2008

Related U.S. Application Data
(63) Continuation-in-part of application No. 11/368,157, filed on Mar. 6, 2006, now abandoned.

(51) Int. Cl. F16B 23/00

(52) U.S. Cl. 411/404

(57) ABSTRACT

A screw with a recess in the head of the screw comprises a screw head; a recess formed in the screw head; a plurality of blocks protruded from a periphery wall of the recess; each block having at least two inclined walls; each of the inclined walls having a slope identical to a slope of the wall. Each block has two inclined walls; and the connection of the inclined walls belonging to one block is formed as an acute angle. Or each block has three inclined walls which are formed as a trapezoidal shape.

The present invention is a continuation in part (CIP) of U.S. patent application Ser. No. 11/368,157 assigned to and invented to the applicant of the present invention. The contents of the U.S. patent application Ser. No. 11/268,157. are incorporated into the present invention as a part of the present invention.

### FIELD OF THE INVENTION

The present invention relates to screws, and in particular to a screw with a recess in the head of the screw, wherein a recess in the head of the screw which comprises a screw head; a recess formed in the screw head; a plurality of blocks protruded from a periphery wall of the recess; each block having at least two inclined walls; each of the inclined walls having a slope identical to a slope of the wall.

### BACKGROUND OF THE INVENTION

Generally, a screw has a head portion. The head portion has a recess. A driving tool is inserted into the recess for driving the screw. The recess may have different shape, for example cruciform shapes, straight trenches, rectangular shapes, hexagonal shapes, etc. The cruciform shapes and straight trenches are general used, but they are easily deformed.

In general, the recess has a polygonal shape and has a plurality of wall which suffers from forces from the driving tools. If the force is too great, the recess will deform or the driving tool will slide out.

The U.S. Pat. No. 6,453,781 and U.S. Pat. No. 2,592,462 disclose screws with different recess designs for improving the defects in the prior art.

In U.S. Pat. No. 6,453,781, a mortise hole is formed with a plurality of lugs. The slopes of the lugs are different from one to one, even they are different from the slope of the mortise hole.

In U.S. Pat. No. 2,592,462, the recess has a block. The slope of the block is design to have a preferred effect as a force is applied thereon. The slope of the block is different from that of the recess.

The two prior arts, U.S. Pat. No. 6,453,781 and U.S. Pat. No. 2,592,462, have different slopes for suffering from forces of a driving tool. However the structure is complicated and unstable. Thereby the price is high and the yield ratio is low.

### SUMMARY OF THE INVENTION

Accordingly, the primary object of the present invention is to provide a screw with a recess in the head of the screw, wherein a driving tool can be inserted into the recess to drive the screw easily. Moreover the driving tool can be firmly secured to the recess so that the operation is easily, inconveniently and effectively.

To achieve above objects, the present invention provides a screw with a recess in the head of the screw which comprises a screw head; a recess formed in the screw head; a plurality of blocks protruded from a periphery wall of the recess; each block having at least two inclined walls; each of the inclined walls having a slope identical to a slope of the wall. Each block has two inclined walls; and the connection of the inclined walls belonging to one block is formed as an acute angle. Or each block has three inclined walls which are formed as a trapezoidal shape.

The various objects and advantages of the present invention will be more readily understood from the following detailed description when read in conjunction with the appended drawing.

### BRIEF DESCRIPTION OF THE DRAWINGS

FIG. 1 shows the first embodiment of the present invention.

FIG. 2 is the cross sectional view of FIG. 1.

FIG. 3 shows the second embodiment of the present invention.

FIG. 4 is the schematic view of FIG. 3.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

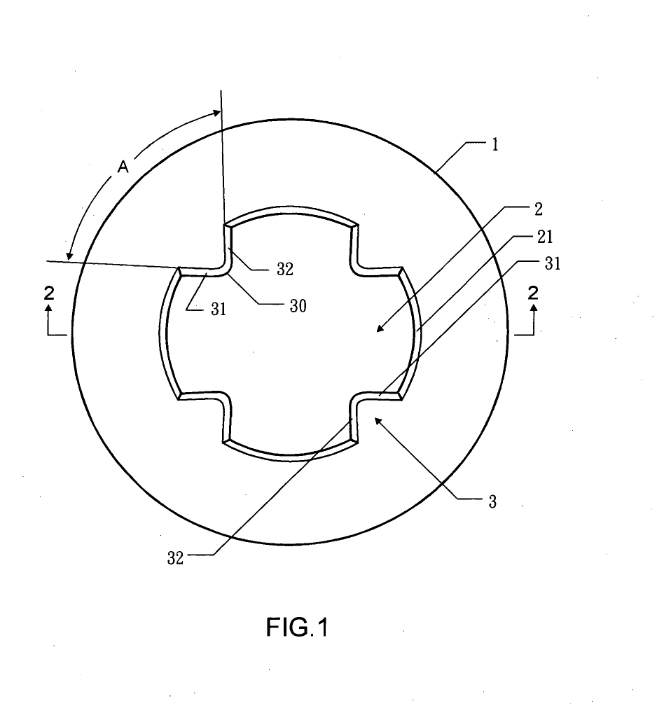

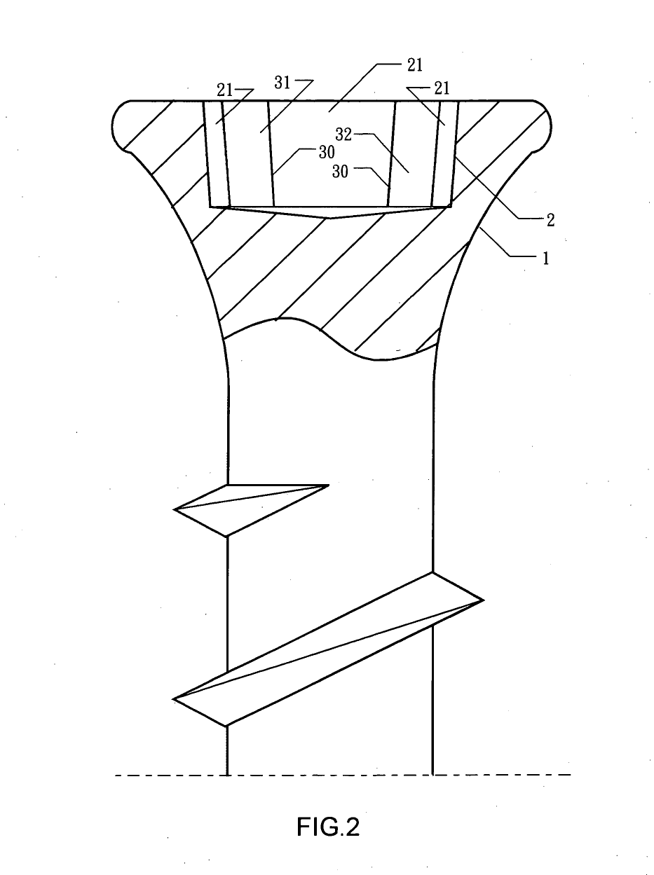

Referring to FIGS. 1 to 2, the first structure of the structure of the present invention is illustrated. The structure has the following elements.

A screw has a screw head 1.

A recess 2 is formed in the screw head 1.

A plurality of blocks 3 are protruded from a periphery wall 21 of the recess 2. Each block 3 has two inclined walls 31, 32. Each of the inclined walls 31, 32 has a longitudinal slope from an upper opening of to a bottom side of the recess and the slope of the inclined walls 31, 32 are identical to a slope of the wall 21. The connection of the inclined walls 31, 32 belong to one block 3 is formed as an angle A. Between two adjacent blocks 3 is formed with a trench; and thus there are totally four trenches are formed. Each trench is formed by three sides which are the inclined wall 31, the periphery wall 21, and another inclined wall 32. The periphery wall 21 is a concave cambered side, and the inclined walls 31, 32 are formed as two straight lateral sides which are two opposite sides of the trench and are parallel. The two adjacent straight lateral sides of two adjacent trenches are approximately vertical to one another and the connection sections of the two adjacent straight lateral sides of two adjacent trenches are formed as a cambered section. All sides of the recess are inclined sides. Each side having a large upper edge near a top end of the screw and a small lower edge near a bottom end of the screw.

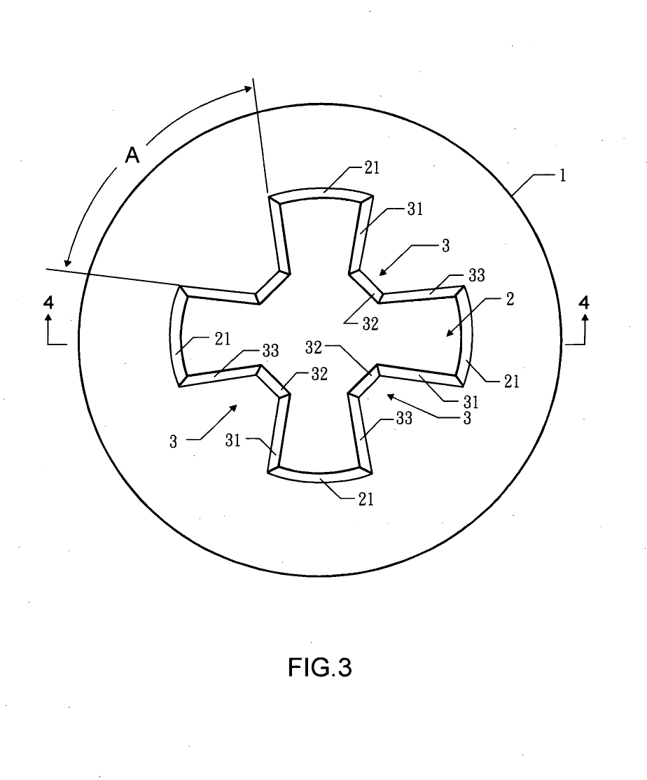

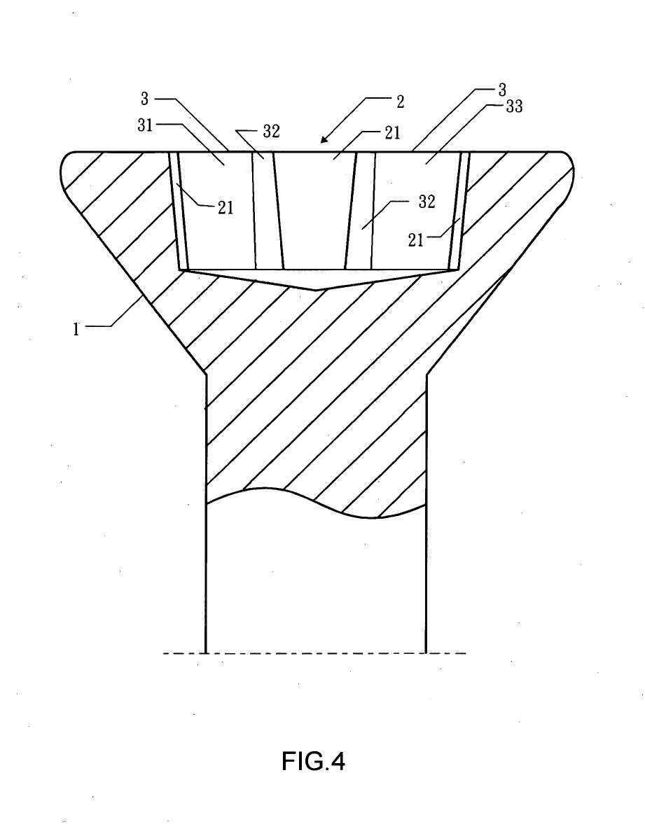

Referring to FIGS. 3 and 4, the second embodiment of the present invention is illustrated.

A screw has a screw head 1.

A recess 2 is formed in the screw head 1.

A plurality of blocks 3 are protruded from a periphery wall 21 of the recess 2. Each block 3 has three inclined walls 31, 32 and 33 which are straight sides. Each of the inclined walls 31, 32, 33 has a longitudinal slope from an upper side of the recess 2 to a bottom side of the recess 2 and the slope is identical to a slope of the wall 21. The three inclined walls 31, 32 and 33 are formed as a trapezoidal shape. Between two adjacent blocks 3 is formed as a trench including the inclined wall 33, the periphery wall 21 and the inclined wall 31. Totally, four trenches are formed. The periphery wall 21 is an concave cambered wall. Extending lines from the inclined walls 31 and 33 adjacent to the same periphery wall are formed as an acute angle.

By above mentioned structure, a driving tool can be inserted into the recess 2 to drive the screw easily. Moreover the driving tool can be firmly secured to the recess 2 so that the operation is easily, inconveniently and effectively.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screw with a recess in a head of a screw comprising:
a screw head;
a recess formed in the screw head;
a plurality of blocks protruded from a periphery wall of the recess; each block having at least two inclined walls; each of the inclined walls having a slope identical to a slope of the wall.

2. The screw as claimed in claim 1, wherein each block has two inclined walls; and the connection of the inclined walls belonging to one block is formed as an acute angle.

3. The screw as claimed in claim 1, wherein each block has three inclined walls which are formed as a trapezoidal shape.

4. A screw with a recess in a head of a screw comprising:
a screw having a screw head;
a recess formed in the screw head; and each recess having an upper opening and a bottom smaller than the upper opening;
a plurality of blocks protruded from periphery walls of the recess; each block having two inclined walls; each of the inclined walls having a longitudinal slope from an upper opening of to a bottom side of the recess and the slope of the inclined walls is identical to a slope of the wall; the connection of the inclined walls of one block being formed as an angle; between two adjacent blocks being formed with a trench; and there being totally four trenches; each trench being formed by three sides which are one periphery wall and two inclined walls adjacent to the periphery wall; the periphery wall being a concave cambered side, and the inclined walls are formed as two straight lateral sides which are two opposite sides of the trench and are parallel; the two adjacent straight lateral sides of two adjacent trenches are approximately vertical to one another.

5. A screw with a recess in a head of a screw comprising:
a screw having a screw head;
a recess formed in the screw head and each recess having an upper opening and a bottom smaller than the upper opening;
a plurality of blocks protruded from periphery walls of the recess; each block having three inclined walls which are straight sides; each of the inclined walls having a longitudinal slope from an upper side of the recess to a bottom side of the recess and the slope being identical to a slope of the wall; the three inclined walls of one block being formed as a trapezoidal shape; between two adjacent blocks being formed as a trench including one periphery wall and two inclined walls adjacent to one periphery wall; totally, four trenches being formed; each periphery wall being an concave cambered wall; extending lines from two inclined walls adjacent to the same periphery wall being intersected with an acute angle.

6. The screw as claimed in claim 1, wherein each block has a trapezoidal shape.
